(19) United States
(12) Patent Application Publication
(10) Pub. No.: US 2012/0181402 A1
(43) Pub. Date: Jul. 19, 2012

(54) ADJUSTABLE BUSHING ASSEMBLIES, PANEL MOUNTING SYSTEMS, AND METHODS

(75) Inventors: Danielle M. Putz, Ogden, UT (US); William Gatti, Sandy, UT (US); Brian Hillstrom, Loretto, MN (US); Bryan K. Harris, Sandy, UT (US)

(73) Assignee: 3FORM, INC., Salt Lake City, UT (US)

(21) Appl. No.: 13/330,036

(22) Filed: Dec. 19, 2011

Related U.S. Application Data
(60) Provisional application No. 61/432,410, filed on Jan. 13, 2011.

(51) Int. Cl. F16M 13/02; F16B 7/14; F16B 35/02; B23P 11/00

(52) U.S. Cl. 248/224.8; 29/525.01; 403/377; 411/384

(57) ABSTRACT

Adjustable bushing assemblies for mounting panels to a support surface include an upper bushing and a lower bushing. The upper bushing is configured to be secured to the lower bushing and prevent over tightening of a fastener secured through the upper and lower bushings. In addition, systems of at least one implementation of the present invention include a plurality of panels mounted to one or more support surfaces using one or more adjustable bushing assemblies.

### CROSS-REFERENCE TO RELATED APPLICATIONS

The present invention claims the benefit of priority to U.S. Provisional Application No. 61/432,410, filed Jan. 13, 2011, entitled “Adjustable Bushing Assemblies, Panel Mounting Systems, and Methods,” the entire content of which is incorporated by reference herein.

### BACKGROUND OF THE INVENTION

1. The Field of the Invention

This invention relates to systems, methods, and apparatus for mounting and/or displaying panels as partitions, displays, barriers, treatments, or other structure.

2. Background and Relevant Art

Recent trends in building design involve adding to the functional and/or aesthetic characteristics of a given structure or design space by mounting one or more decorative panels thereto. This is at least partly since there is sometimes more flexibility with how the given panel (or set of panels) is designed, compared with the original structure. For example, panel materials include glass, wood, and polymeric resin materials, which can formed as panels to be used as partitions, walls, barriers, treatments, décor, signs, etc., in offices, homes, and other settings.

As mentioned above, one particular use of decorative resins can be in the panel form, where the panel might be used in conjunction with a panel mounting system as part of a partition, display, barrier, treatment, or other structure. One conventional type of panel mounting system includes mounting panels to a structure (e.g., wall, ceiling, or corresponding frame) using one or more standoffs. In general, a standoff positions a panel at a “standoff” (or extended) position with respect to a support structure (e.g., a wall). The standoff position is a distance defined generally by a length of a portion of the standoff (i.e., the standoff barrel).

To this end, a conventional standoff typically includes a standoff barrel that attaches to the given support structure on one end, and a fastener that has a threaded rod configured to twist inside the standoff barrel on an opposing end. The fastener and barrel structures are generally configured to screw together with substantially flat, opposing surfaces. For example, the fastener might be threaded through one side of a given aperture in a panel. The fastener might then be screwed into the standoff barrel on an opposing side of the panel perforation.

Unfortunately, conventional panel mounting systems such as these tend to suffer from a number of drawbacks. For example, installers often can provide too much torque to the fastener. Such increased forces can cause one or more components of the standoff to dig into the panel, which can lead to panel damage.

Additionally, conventional mounting hardware often does not account for the material properties of the particular type of panel being used; and thus, can lead to panel damage. For instance, many conventional mounting hardware options employ a metal-to-panel interface. Such metal-to-panel interfaces can create stress concentrations in both glass and acrylic panels that eventually lead to the creation of creaks and fissures in the panel.

Accordingly, there are a number of disadvantages in conventional panel mounting systems and hardware that can be addressed.

### BRIEF SUMMARY OF THE INVENTION

Implementations of the present invention provide systems, methods, and apparatus for mounting panels as partitions, displays, barriers, treatments, or other structure that help decrease or eliminate panel damage. For example, one or more implementations include adjustable bushing assemblies that prevent over-tightening of hardware components and associated panel damage. Additionally, the adjustable bushing assemblies may limit the amount of force exerted on a panel during installation. For instance, the adjustable bushing assemblies are adaptable for use with panels of various gauges and sizes as well as material types and configurations. Accordingly, implementations of the present invention can be easily adapted to the environment of use and provide a number of secure mounting options.

For example, an implementation of an adjustable bushing assembly includes a standoff barrel and a fastener configured to be secured thereto. The adjustable assembly also includes a lower bushing configured to be positioned between the fastener and the standoff barrel. Additionally, the adjustable bushing assembly includes an upper bushing variably securable to the lower bushing in any of a plurality of positions. The upper bushing is further configured to limit the how far the fastener can be advanced relative to the standoff barrel.

Additionally, an implementation of a panel mounting system includes one or more adjustable bushing assemblies for securing a panel to a support surface. Each of the adjustable bushing assemblies comprise a standoff barrel and a fastener that is secured to the standoff barrel. Each of the adjustable bushing assemblies also includes a lower bushing positioned between the fastener and the standoff barrel. In addition to the foregoing, each adjustable bushing assemblies includes an upper bushing selectively secured to the lower bushing so as to be spaced from the standoff barrel at a predetermined distance. The system further includes a panel secured between the standoff barrel and the fastener, the panel having a thickness less than the predetermined distance such that upper and lower bushings prevent the fastener from being advanced into the panel.

In addition to the foregoing, a method of mounting panels can involve providing a panel having a thickness and at least one through hole. The method also involves securing the standoff barrel to a support surface. Furthermore, the method involves selectively securing the upper bushing to the lower bushing at a predetermined distance from the standoff barrel based on the thickness of the panel. The method involves aligning the at least one through hole with the standoff barrel. The method further involves positioning a fastener in the through hole of the panel and securing the fastener to the standoff barrel. Finally, the method involves advancing the fastener relative to the standoff barrel until the upper bushing prevents further advancement of the fastener.

Additional features and advantages of exemplary implementations of the present invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, the like elements have been designated by like reference numbers throughout the various accompanying figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic diagram in which a plurality of panels are mounted to a support surface via a plurality of adjustable bushing assemblies in accordance with an implementation of the present invention;

FIG. 2 illustrates an exploded view of an adjustable bushing assembly in accordance with an implementation of the present invention;

FIG. 3 illustrates an assembled, side cross-sectional view of the adjustable bushing assembly of FIG. 2;

FIG. 4 illustrates a side view of a positioning tool being used to position an upper bushing relative to a lower bushing according to an implementation of the present invention.

FIG. 5 illustrates a side cross-sectional view of an adjustable bushing assembly with a recessed lower bushing in accordance with an implementation of the present invention;

FIG. 6 illustrates an exploded view of another adjustable bushing assembly in accordance with an implementation of the present invention; and

FIG. 7 illustrates a side cross-sectional view of the adjustable bushing assembly of FIG. 6.

### DETAILED DESCRIPTION OF THE PREFERRED EMBODIMENTS

Implementations of the present invention provide systems, methods, and apparatus for mounting panels as partitions, displays, barriers, treatments, or other structure that help decrease or eliminate panel damage. For example, one or more implementations of the present invention include adjustable bushing assemblies that prevent over-tightening of hardware components and associated panel damage. Additionally, the adjustable bushing assemblies may limit the amount of force exerted on a panel during installation. For example, the adjustable bushing assemblies are adaptable for use with panels of various gauges and sizes as well as material types and configurations. Accordingly, implementations of the present invention can be easily adapted to the environment of use and provide a number of secure mounting options.

In particular, one or more implementations include an adjustable bushing assembly having a standoff barrel, a fastener, an upper bushing, and a lower bushing. The upper bushing in turn can act as a stop that limits how far the fastener can be advanced relative to the standoff barrel. In particular, the upper bushing is variably securable to the lower bushing in any of a plurality of positions. Thus, an installer can secure the upper bushing to the lower bushing so the upper bushing is spaced a predetermined distance from a standoff barrel. An installer can base the predetermined distance on the gauge or thickness of a panel so as to prevent the fastener from being over tightened into the panel.

Accordingly, one will appreciate from the description herein that the components of the present invention can reduce the likelihood of damaging the panels, in addition to providing a secure mount of the panel to a structure. For instance, the adjustable bushing assemblies of the present invention can reduce or prevent mounting hardware from creating stress concentrations in mounted panels. Additionally, one or more implementations of the present invention include systems and components, which in order to reduce likelihood of panel damage, provide a barrier between the panels and any harder mounting components.

As a preliminary matter, implementations of the present invention are described herein primarily with reference to mounting panels, such as glass or resin panels. One will appreciate, however, that a panel, particularly a glass or resin-based panel, is only one type of “structure” with which the adjustable bushing assemblies described herein can be used. For example, the adjustable bushing assemblies can be used to mount other types of structures having different material compositions, such as objects comprising wood, stone, fiberglass, or the like, which may or may not exhibit primarily panel-like dimensions as described herein. Reference herein, therefore, to panels, or even glass or resin panels, as such, is primarily for convenience in description.

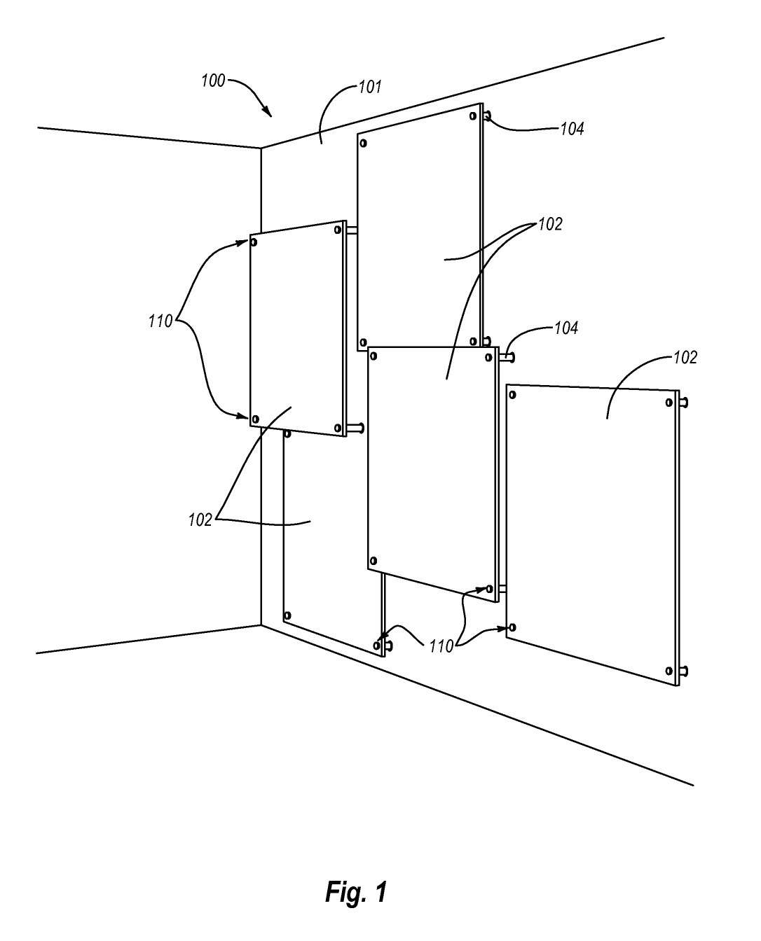

FIG. 1 illustrates a schematic diagram of a system 100 comprising a plurality of panels 102 mounted to a support surface 101. As shown, one or more adjustable bushing assemblies 110 secure each panel 102 of the plurality of panels 102 to the support surface 101. As explained in further detail below, the adjustable bushing assemblies 110 securely mount the panels 102 without damaging them, while also providing a pleasing aesthetic. One or more implementations include adjustable bushing assemblies 110 that include a standoff barrel 104, which can be used to “standoff” or hold the panel 102 at a specified distance from the support surface 101.

As shown in FIG. 1, a standoff barrel 104 can be used to “standoff” or hold a panel 102 a specified distance from a support surface 101. As used herein the terms “proximal” and “distal” are in reference to the support surface. By contrast, the term “distal” shall refer to a positional relationship of a described feature or sub-feature as being farther from the support surface 101.

In at least one implementation, an anchor fixed within the support surface 101 can secure the standoff barrel 104 to the support surface 101. For example, if the support surface is made from wood, a wood anchor can secure the proximal end of the standoff barrel 104 thereto. Additionally, as shown in FIG. 1, standoff barrels 104 of varying length can create a desired aesthetic affect.

In one or more implementations the support surface to which the adjustable bushing assemblies are secured can comprise a vertical or substantially vertical surface. For example, FIG. 1 illustrates a wall as a support surface 101. In alternative implementations, the support surface 101 can be substantially horizontal (e.g., a floor or a ceiling) or angled (e.g., an angled wall or a ceiling).

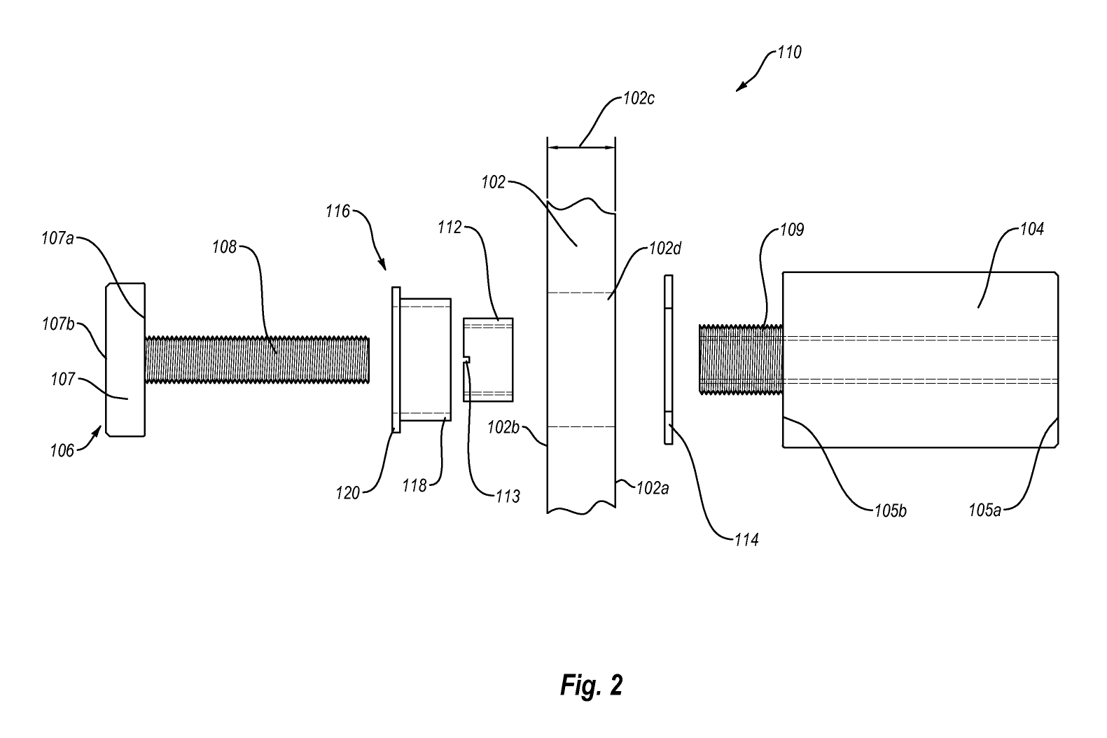

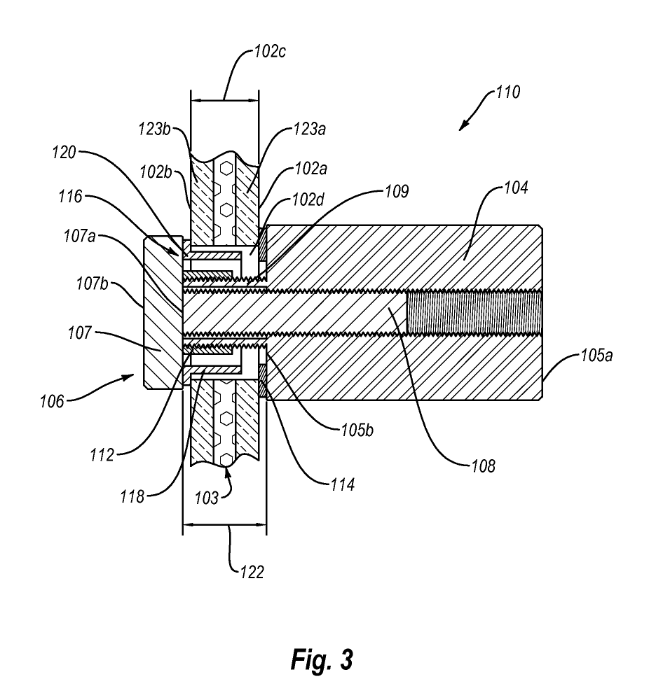

FIGS. 2 and 3, and the corresponding text, illustrate or describe a number of details and features of one implementation of the adjustable bushing assembly 110 shown in FIG. 1. For example, FIG. 2 provides an exploded-view of an adjustable bushing assembly 110 according to at least one implementation of the present invention. FIG. 3 on the other hand, illustrates a cross-sectional view of the adjustable bushing assembly 110 in an assembled form.

As illustrated in FIGS. 2 and 3, in at least one implementation, the adjustable bushing assembly 110 can include a standoff barrel 104 and a fastener 106. The fastener 106 is securable to the standoff barrel 104. For example, an installer can secure the fastener 106 by advancing the fastener 106 into the standoff barrel 104. Securing the fastener 106 to the standoff barrel 104 can, thereby, secure the panel 102 to the adjustable bushing assembly 110.

The adjustable bushing assembly 110 also can include a lower bushing 109 and an upper bushing 112. As explained in greater detail below, the lower bushing 109 and the upper bushing 112 can act as a stop and prevent an installer from applying too much force to the panel 102 with the fastener 106. In light of the disclosure herein, one will appreciate that applying too much force to the panel 102 can damage the panel 102. Thus, by limiting the amount of force that can be applied by the fastener 106 to the panel 102, the adjustable bushing assembly 110 can prevent damage to the panel 102.

The adjustable bushing assembly 110 also can include a proximal washer 114, disposed between a distal end 105b of the standoff barrel 104 and a proximal surface 102a of the panel 102. Similarly, the installer can place a distal washer 116 between a distal surface 102b of the panel 102 and a head 107 of the fastener 106. The proximal and distal washers 114, 116 can provide a flexible and/or compressible, cushioning barrier between the harder standoff barrel 104 and head 107 and the softer or more fragile material of the panel 102.

To limit the amount of force exerted on the panel 102 the upper bushing 112 can couple to the lower bushing 109, and can come into contact with the head 107 of the fastener 106. The standoff barrel 104 can include a secured, coupled, or integrated lower bushing 109. In at least one implementation, the lower bushing 109 can protrude out from a distal end 105b of the standoff barrel 104, as illustrated in FIGS. 2 and 3. In at least one implementation, after coming in contact with the head 107, the upper bushing 112 may impede or prevent further advancement of the fastener 106 into the standoff barrel 104. Hence, the upper bushing 112 can counteract any further advancement of the fastener 106 toward the standoff barrel 104 and, consequently, any further advancement of the head 107, once a proximal surface 107a of the head 107 makes contact with the upper bushing 112.

Advancing the fastener 106 into the standoff barrel 104 may result in the proximal surface 107a of the head 107 and/or the distal end 105b of the standoff barrel 104 exerting excessive force on the panel 102, which may damage the panel 102. Therefore, limiting the advancement of the fastener 106 relative to the standoff barrel 104 to a predetermined distance can limit the amount of force that may be exerted on the panel 102 by the proximal surface 107a and/or by the distal end 105b of the standoff barrel 104 (directly and indirectly—i.e., through an intervening element). Furthermore, although in some instances certain amount of force on the panel 102 may be necessary to secure the panel 102 to the adjustable bushing assembly 110, applying excessive force can damage the panel 102. Hence, limiting the advancement of the fastener 106 to a predetermined position, can limit the applied force, which may prevent damaging the panel 102.

In at least one implementation, the lower bushing 109 can include external threads. To mate with the external threads of the lower bushing 109, the upper bushing 112 can have internal threads configured to engage the external threads of the lower bushing 109. The thread pitch can vary depending on the preference of the installer. For instance, the lower bushing 109 and the upper bushing 112 can have fine-pitched thread, which can allow the installer to advance the upper bushing 112 with respect to the lower bushing 109 at a controller rate.

The upper bushing 112 also can include one or more recesses 113 to aid in attaching the upper bushing 112 to the lower bushing 109 as explained below. In any event, as shown in FIGS. 2 and 3, the installer can secure the upper bushing 112 at a position along the lower bushing 109. The combination of the lower bushing 109 and the upper bushing 112 can then act as a stop, which allows the fastener 106 advance within the standoff barrel 104 to a predetermined distance. In particular, as the installer threads the fastener 106 into the standoff barrel 104, the proximal surface 107a of the head 107 can contact the upper bushing 112, which in turn can prevent or impede the fastener 106 from advancing farther into the standoff barrel 104.

In one or more implementations, the fastener 106 can have a rod 108 that can couple to the standoff barrel 104. For example, the rod 108 can have external threads, which can mate with internal threads of the standoff barrel 104. In one or more implementations, the upper and lower bushings 112, 109 that have different thread handedness than the threads of the rod 108. For example, the standoff barrel 104 and the rod 108 can have right-handed threads, while the upper bushing 112 and the lower bushing 109 can have left-handed threads.

Providing different thread handedness, as described above, may further aid in limiting the advancement of the fastener 106 to a desired, predetermined position within the standoff barrel 104. In particular, the different handedness can prevent the upper bushing 112 from being advanced further along the lower bushing 109 as the fastener 106 is advanced into the standoff barrel 104. In other words, different handedness can prevent the friction between the proximal surface 107a and the upper bushing 112 can from rotating the upper bushing 112, thereby advancing the upper bushing 112 along the lower bushing 109 as the fastener 106 is rotated into the standoff barrel 104.

As shown by FIG. 3, the installer can set the upper bushing 112 in a position along the lower bushing 109 to create a gap 122 between the proximal surface 107a of the head 107 and the distal end 105b of the standoff barrel 104. The installer can insure that the gap 122 is properly sized so as not to create unwanted stresses in the panel 102. For example, the installer can set the upper bushing 112 in position along the lower bushing 109 to insure the gap 122 between washers 114 and 116 is slightly larger than the gauge of the panel 102. Alternatively, the installer can set the gap 122 such that the head 107 and the standoff barrel 104 (or the distal washer 116 and the proximal washer 114) can apply a desired but not excessive amount of force onto the distal surface 102b a proximal surface 102a, respectively.

As described above, the fastener 106 can have a head 107, which can help to secure the panel 102 to the adjustable bushing assembly 110. For instance, the head 107 in combination with the standoff barrel 104 can hold the panel 102 therebetween. As such, the fastener 106 and the standoff barrel 104 can fix the panel 102 with respect to the adjustable bushing assembly 110 as well as to the support surface 101 (FIG. 1).

The head 107 of the fastener 106 also can have a distal surface 107a. The proximal and/or distal surfaces 107a, 107b can have a substantially flat surface configuration. Alternatively, the fastener 106 can have a conical or partially conical proximal surface 107a, such that would allow all or portion of the head 107 to submerge below the distal surface 102b of the panel 102. Moreover, the conical proximal surface 107a may align an aperture 102d of the panel 102 to be concentric with the standoff barrel 104, when the fastener 106 is in a fully threaded position. Additionally or alternatively, the head 107 can have a shaped distal surface 107b; for example, the distal surface 107b of the head 107 may have a hemispherical shape.

The fastener 106 can comprise a number of suitable materials including but not limited to steel, brass, aluminum, wood, or high strength polymers. In one or more implementations, the fastener 106 also can comprise multiple materials. For example, a manufacturer can make the rod 108 from steel and the head 107 from plastic or brass. Furthermore, the fastener 106 can incorporate plating or coating, which can partially or wholly cover the fastener 106, and which can improve corrosion resistance and/or appearance the fastener 106.

Along related lines, the manufacturer can make the standoff barrel 104 from any suitable material, which can provide necessary strength characteristics and/or desired aesthetic appeal. For example, the manufacturer can make the standoff barrel from a metal, such as steel, brass, bronze, copper, aluminum, and titanium. Alternatively, the standoff barrel 104 can comprise a nonmetallic material, such as wood, thermoplastic resin (e.g., glass-filled nylon, polycarbonate, etc.), or a carbon fiber reinforced polymer.

The standoff barrel 104 also can incorporate a coating or plating that can protect the standoff barrel 104 from environmental elements. Moreover, the standoff barrel 104 can have polished, textured, or patterned surfaces. For instance, the proximal end 105a of the standoff barrel 104 can include a texture or pattern for increased friction between the standoff barrel 104 and the support surface 101.

In one or more implementations, the adjustable bushing assembly 110 may include a standoff barrel 104 that has a substantially circular cross-section (i.e., a substantially cylindrical shape) as shown in FIGS. 2 and 3. Alternatively, the standoff barrel 104 can have a cross-section of a basic geometric shape, such as elliptical, rectangular, triangular, or trapezoidal, or may have a cross-section of an irregular shape. One or more implementations may include a standoff barrel 104 with a cross-section that has at least one dimension in one in the following ranges, approximately between: 0.5 inch to 2.0 inches, 1.0 inch to 4.0 inches, and 2.0 inches to 6.0 inches.

The proximal washer 114, which can rest between the proximal surface 102a and the distal end 105b, can insure that the standoff barrel 104 does not scratch the panel 102. Additionally, the proximal washer 114 can insure that the edges of the standoff barrel 104 do not dig into—and create point stresses within—the panel 102 that can eventually lead to panel damage, such as cracks and fissures. The proximal washer 114 also can help to prevent panel damage when the installer installs glass and acrylic panels, which can have particularly high susceptibility to damage when mounted against a metal surface.

In at least one implementation, the proximal washer 114 can have a higher coefficient of friction than the distal end 105b of the standoff barrel 104. Consequently, the proximal washer 114 can generate static friction forces applied at the interface of the proximal washer 114 and the proximal surface 102a. Such static friction forces can act to fix and/or hold the panel 102 stationary with respect to the adjustable bushing assembly 110 and to the support surface 101. Therefore, a higher ratio of static friction forces to force applied at an interface can result in lower force required to be applied at the interface of the panel 102 and the adjustable bushing assembly 110, in order to fix and/or hold the panel 102 stationary with respect to the adjustable bushing assembly 110.

In light of this disclosure, one will appreciate that the proximal washer 114 can comprise polytetrafluoroethylene, rubber, nylon, or other suitable material that is light weight, durable, and that can provide a resilient barrier between the distal end 105b of the standoff barrel 104 and the proximal surface 102a of the panel 102. The proximal washer 114 also can comprise a material that has approximately the same or similar coefficient of thermal expansion as the panel 102. Thus, the proximal washer 114 can expand and contract at approximately the same rate as the panel 102 and can thereby insure that there is always an adequate barrier between the harder metal features of the standoff barrel 104 and the softer panel 102.

In one or more implementations, the standoff barrel 104 also can have an integrated proximal washer 114. For example, the manufacturer can glue the proximal washer 114 to the distal end 105b. Additionally or alternatively, the manufacturer can overmold, whether partially or wholly, the standoff barrel 104, such as to form a sufficiently thick layer of suitable thermoplastic or elastomeric material on the distal end 105b. Such layer of overmolded material can function as the proximal washer 114 in the manner described above.

Similar to the proximal washer 114, the distal washer 116 can rest between the proximal surface 107a and the distal surface 102b. The distal washer 116 can have a flange 120 configured to rest against the distal surface 102b of the panel 102. The flange 120 can provide a soft and/or compressible barrier between the head 107 of the fastener 106 and the distal surface 102b of the panel 102. The flange 120 can have an outside diameter that is approximately equal to the outside diameter of the head 107. Alternatively, the outside diameter of the flange 120 can be less than the outside diameter of the head 107 (e.g., the flange 120 can have the outside diameter that is approximately ⅔ of the outside diameter of the head 107).

Additionally, the distal washer 116 can include a hollow, cylindrical body 118 configured to fit within the aperture 102d of the panel 102. The cylindrical body 118 can span approximately between the distal surface 102b and the proximal surface 102a. Alternatively, the cylindrical body 118 can span less than a distance between the distal and proximal surfaces 102b, 102a. In at least one implementation, the cylindrical body 118 can insure that the rod 108 of the fastener 106 does not directly contact the panel 102.

Furthermore, similar to the proximal washer 114, the distal washer 116 can have a higher coefficient of friction than the proximal surface 107a. Additionally, the distal washer 116 can comprise polytetrafluoroethylene, rubber, nylon, or other suitable material that is light weight, durable, and that can provide a resilient barrier between the metal components of the adjustable bushing assembly 110 and the panel 102. The distal washer 116 also can comprise materials configured with approximately the same or similar coefficient of thermal expansion as the panel 102. Thus, the distal washer 116 can expand and contract at approximately the same rate as the panel 102, and can thereby insure that there is always an adequate barrier between any metal components of the adjustable bushing assembly 110 and the panel 102.

Additionally or alternatively, the fastener 106 can have an integrated distal washer 116. For example, the manufacturer can glue the distal washer 116 to the proximal surface 107a of the head 107. The manufacturer also can overmold the fastener 106 and/or the head 107 with a suitable thermoplastic or elastomeric material, such as to form the distal washer 116 that can suitably interface with the distal surface 102b of the panel 102.

In one or more implementations, the fastener 106 can include the threaded rod 108, which can fit through the aperture 102d and screw into the standoff barrel 104, thereby securing the panel 102 to the adjustable bushing assembly. Alternatively, the adjustable bushing assembly 110 can include a fastener 106 that can couple to the standoff barrel 104 by means other than threading. For example, the installer can press fit (i.e., via an interference fit) the rod 108 into the standoff barrel 104. Alternatively, the adjustable bushing assembly 110 also may include a fastener 106 with a tapered rod 108, such that the taper of the rod 108 has a locking taper angle (e.g., 3°), which interlocks with a matching taper in the standoff barrel 104. In still further implementations, the rod 108 and standoff barrel 104 can have a friction, interference, or snap-fit configuration.

For example, the rod 108 can include one or more substantially circular internal or external grooves, and one or more snap rings can fit into or about the grooves to secure the fastener 106 to the standoff barrel 104. Additionally or alternatively, a cotter pin or another type of retaining pin can fit into the fastener 106 to secure the fastener 106 to the standoff barrel 104. Furthermore, the fastener 106 can have a rivet-like configuration, such that the installer can rivet the fastener 106 to the standoff barrel 104. In at least one implementation, the rod 108 of the fastener 106 can fit sufficiently tightly, either directly or indirectly (e.g., with a bushing) within the aperture 102d of the panel 102, such that the panel may be held substantially stationary with respect to the adjustable bushing assembly 110 and the support surface 101. In light of this disclosure, those skilled in the art can appreciate numerous alternative ways of securing the fastener 106 to the standoff barrel 104.

As shown in FIG. 3, in one or more implementations the panel 102 can comprise a decorative glass laminate, which can include outer glass sheets 123a, 123b and an interlayer 103. The interlayer 103 can include one or more decorative objects (such as thatch reed, rocks, flowers, fabric, etc.) suspended in resin. The resin of the interlayer 103 can provide the interlayer 103 with elasticity and/or compressibility. In light of this disclosure, one will appreciate that decorative glass laminates can have a particularly high susceptibility to panel damage due to applying excessive amount of force to the panel 102 via the fastener 106. In particular, the compressible interlayer 103 can allow the outer glass sheets 123a, 123b to flex in response to the force applied by the proximal surface 107a of the head 107 and the distal end 105b of the standoff barrel 104. Hence, in some instances, the outer glass sheets 123a, 123b of glass laminates can crack or fracture under a lesser load or pressure than, for example, a solid glass panel.

Thus, a lower amount of force applied by the head 107 of the fastener 106 can crack or otherwise damage a decorative glass laminate than the force (applied under similar circumstance) that would crack or otherwise damage a unitary glass or resin-based panel. Furthermore, the minimum amount of force that will crack a decorative glass laminate can depend on one or more of the thickness of the outer glass sheets 123a, 123b, the thickness of the resin interlayer 103, the type of resin used in the interlayer 103, and/or the type of decorative objects suspended in the interlayer 103. For example, the thicker the interlayer 103, the easier the panel 102 may deform. Thus, in some instances, the thicker the interlayer 103, the lower the minimum amount of force required to crack or otherwise damage the outer glass sheets 123a, 123b. Hence, to prevent damage to the panels 102, the adjustable bushing assembly 110 can limit the amount of force exerted onto the panel 102 by the adjustable bushing assembly 110.

The ability to vary the position of the upper bushing 112 relative to the lower bushing 109 can insure that the fastener 106 will not exert excessive force onto the panel 102. Additionally, the ability to vary the position of the upper bushing 112 relative to the lower bushing 109 can facilitate using the adjustable bushing assembly 110 with panels 102 of various gauges. For example, the adjustable bushing assembly 110 secure panels having a gauge between about one-eighth inch (⅛″) and about two inches (2″).

One will appreciate in light of the disclosure herein that the ability to vary the position of the upper bushing 112 relative to the lower bushing 109 can allow the installer to preset the amount of force that will act on the decorative glass laminate. The adjustable bushing assembly 110 can allow the installer to insure that the decorative glass laminate does not experience force or other stress that will crack or otherwise damage the outer glass sheets 123a, 123b. To insure application of adequate force, the installer can vary the position of the upper bushing 112 relative to the lower bushing 109 based one or more of the type of panel, the gauge of panel, the thickness of the outer glass sheets 123a, 123b, the thickness of the resin interlayer 103, and/or the type of decorative objects suspended in the resin interlayer to prevent damage to the panel 102.

In at least one implementation, the installer can use a positioning tool to insure proper positioning of the upper bushing 112 relative to the lower bushing 109.

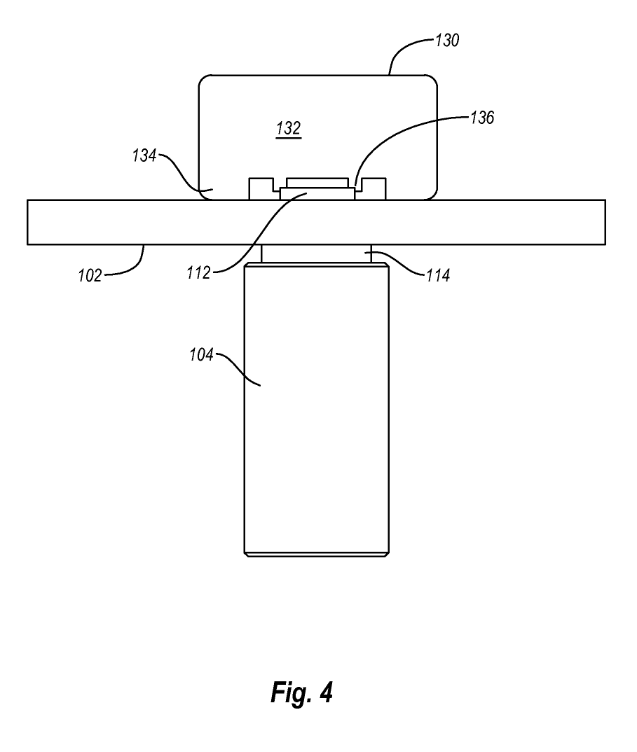

FIG. 4 illustrates a positioning tool 130 that the installer can use to properly position the upper bushing 112. The positioning tool 130 can include a handle 132, a shoulder 134, and one or more teeth 136. The installer can insert the one or more teeth 136 in the recesses 113 of the upper bushing 112.

The installer also can apply a torque to the positioning tool 130, thereby causing the upper bushing 112 to turn and advance along the lower bushing 109. Eventually, the shoulder 134 of the positioning tool 130 can contact the panel 102. This can indicate proper positioning of the upper bushing 112 relative to the lower bushing 109. One will thus appreciate that the shoulder 134 can have such size and configuration as to insure proper positioning of the upper bushing 112.

According to one or more implementations of the present invention, the manufacturer can use aluminum to make the positioning tool 130. For example, the manufacturer can use a sheet metal to form the positioning tool 130. More specifically, the manufacturer can form the positioning tool 130 using a stamping die. Stamping the positioning tool out of sheet metal can increase manufacturing efficiency and reduce costs associating with making the positioning tool 130. One will appreciate, however, that the positioning tool 130 can comprise any suitable material that is light-weight and strong.

In at least one implementation, the positioning tool 130 can have one or more rounded edges, such that when the positioning tool 130 comes into contact with the panel 102, the positioning tool 130 will not scratch or otherwise damage the panel 102. For example, if the positioning tool 130 is used to properly position the upper bushing 112 with respect to the lower bushing 109 by rotating the upper bushing 112, the positioning tool 130 may have rounded edges that face the direction of the rotation of the positioning tool 130. The rounded edges of the positioning tool 130 can prevent the positioning tool 130 from digging into a surface of the panel 102.

The relatively small size of the positioning tool 130 also can allow a user to easily manipulate it with one hand. In particular, the positioning tool 130 can have size and configuration such as to fit in the palm of a user's hand. The small size and manipulability of the positioning tool 130 also can help insure that a user does not scratch the panel 102 while tightening the upper bushing 112 onto the lower bushing 109.

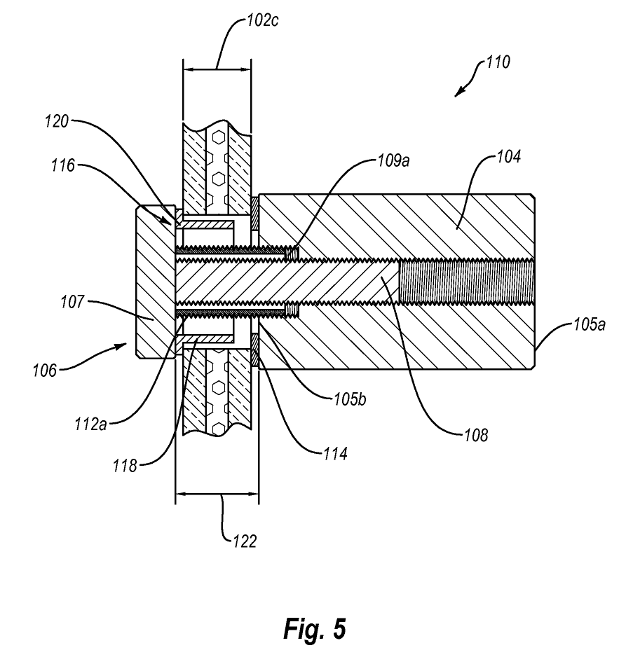

As described above in connection with FIGS. 2 and 3, the lower bushing 109 can have external threads that can mate with internal threads of the upper bushing 112. Moreover, the lower bushing can protrude outward from the distal end 105b of the standoff barrel 104. In light of this disclosure, however, one skilled in the art will appreciate that the lower and upper bushings 109, 112 are not so limited. For example, FIG. 5 illustrates another adjustable bushing assembly 110, similar to the adjustable bushing assembly 110 shown in FIGS. 2 and 3, albeit that the lower bushing 109a is integrated into the channel of the standoff barrel 108.

In particular, the standoff barrel 108 can comprise a first internally threaded bore that forms the lower bushing 109a. The internal threads of the lower bushing 109a can mate with external threads of an upper bushing 112a. Thus, an installer can thread the upper bushing 112a into the internal bore that forms the lower bushing 109a.

As shown by FIG. 5, the rod 108 can extend through the upper bushing 112a and the lower bushing 109a and into the standoff barrel 104. In particular, a second internally threaded bore formed in the standoff barrel 104 can receive and secure the rod 108 therein.

In any event one will appreciate that the standoff barrel 104 can have an integrated lower bushing 109. For instance, the lower bushing 109a can recess into the distal end 105b of the standoff barrel 104 as shown in FIG. 5, or alternatively extend away from the distal end 105b of the standoff barrel. One will appreciate in light of the disclosure herein that the manufacturer can reduce at least material costs by using a recessed lower bushing 109a as shown in FIG. 5.

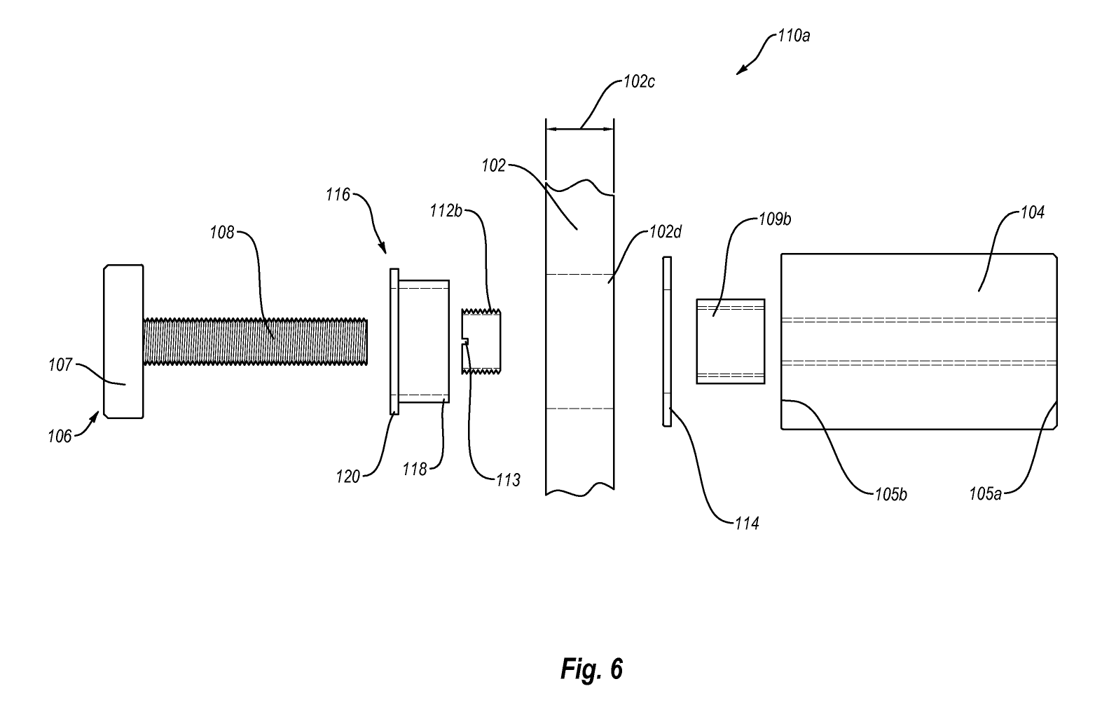

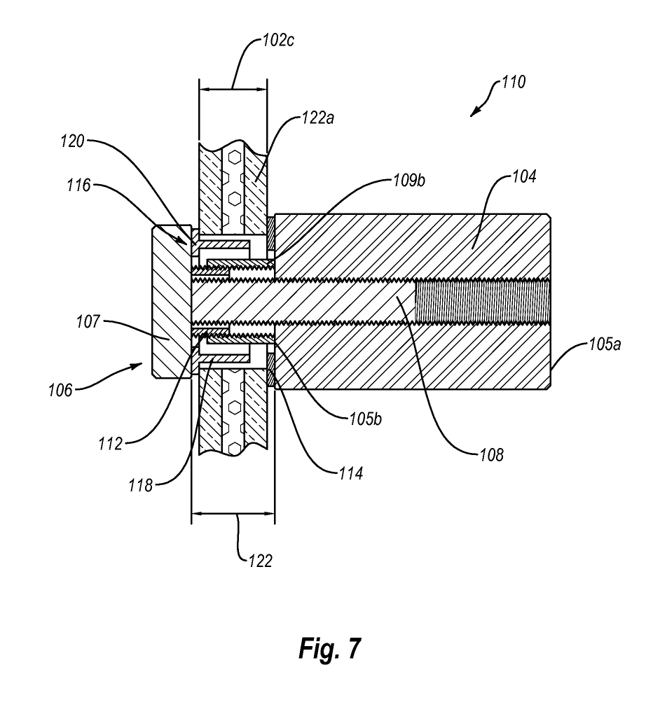

The adjustable bushing assembly 110 shown and described in reference to FIGS. 2, 3, and 5 includes a lower bushing 109 secured to or integrated with the standoff barrel 104. One will appreciate that the present invention is not so limited. For example, FIGS. 6 and 7 illustrate another implementation of an adjustable bushing assembly 110a. The adjustable bushing assembly 110a includes a standoff barrel 104, a fastener 106, a proximal washer 114, and a distal washer 116 similar to those of the adjustable bushing assembly 110.

The adjustable bushing assembly 110a also includes an upper bushing 112b and a lower bushing 109b. The lower bushing 109b can have size and configuration that may allow the lower bushing 109b to removably couple to or stay in contact with the standoff barrel 104. Similar to the upper bushing 112 and a lower bushing 109 described above, the lower bushing 109b and upper bushing 112b can act as a stop and can prevent the installer from over tightening or applying too much force with the fastener 106 onto the panel 102. Thus, the adjustable bushing assembly 110a can prevent damage to the panel 102.

As shown by FIGS. 6 and 7, the lower bushing 109b can include internal threads. The upper bushing 112b also can have external threads configured to mate with the internal threads of the lower bushing 109b. Alternatively, similar to the upper bushing 112, as described in connection with FIG. 5, the upper bushing 112b can have internal threads configured to mate with the internal thread of the lower bushing 109b.

The upper bushing 112b also can include one or more recesses 113 to aid in attaching the upper bushing 112b to the lower bushing 109b as explained above. In any event, as shown in FIG. 7, the installer can secure the upper bushing 112b in position along the lower bushing 109b. The combined lower bushing 109b and upper bushing 112b can then act as a stop that allows the fastener 106 to be inserted within the standoff barrel 104 a predetermined distance. In particular, the as an installer threads the fastener 106 within the standoff barrel 104, the head 107 of the fastener 106 will contact the upper bushing 112b, which in turn will prevent the fastener 106 from advancing farther into the standoff barrel 104.

In at least one implementation, the adjustable bushing assembly 110a also can include proximal washer 114 and/or distal washer 116. The proximal washer 114 and distal washer 116 can be configured in a similar or the same manner and from similar or the same materials as described above in connection with FIGS. 2 and 3. Furthermore, it should be noted that, other than the different configuration of the upper bushing 112 and upper bushing 112b and/or lower bushing 109 and lower bushing 109b, the adjustable bushing assembly 110a can be configured and can function in a similar or the same manner as the adjustable bushing assembly 110, described above.

Additionally, implementations of the adjustable bushing assembly 110, 110a are not limited to threaded upper and lower bushings. In at least one implementation the upper and/or lower bushings can have corresponding notches and grooves, such that a notch of one bushing may fit into a corresponding groove in the other bushing. Alternatively, the upper and lower bushings may comprise a ball-and-groove system, such that one bushing may have a spring-loaded ball that may fit into a corresponding groove in the other bushing. As the upper bushing advances toward the lower bushing, the installer can position the notch (or spring-loaded ball) in the desired groove along the lower bushing, such that would render the upper bushing immobilized from further movement. Subsequently, the upper bushing can act as a stop and can limit the advancement of the fastener.

In at least one implementation, the upper and lower bushings can have an interference fit with each other. The interference between the dimensions of the upper and lower bushings can render the upper bushing sufficiently immobilized, such that the upper bushing can act as a stop and limit advancement of the fastener into the standoff barrel. Furthermore, in light of the disclosure herein, those skilled in the art should appreciate other implementation of the lower and upper bushings.

Implementations of the present invention also include methods of assembling and securing panels as a partition, display, treatment, barrier, or other structure to the support surface. The following describes at least one implementation of a method of mounting panels 102 to a support surface 101 using adjustable bushing assemblies 110 as shown in FIGS. 1-7. Of course, as a preliminary matter, one of ordinary skill in the art will recognize that the methods explained in detail can be modified to install a wide variety of configurations using one or more components of the present invention.

In at least one implementation, the method can involve providing a panel 102 having a thickness 102c and at least one through hole 102d. Next, the installer can secure the standoff barrel 104 to a support surface 101. For example, installer can attach an anchor to the support surface 101 and then attach the standoff barrel 104 to the anchor.

The method can further involve selectively securing the upper bushing 112, 112a, 112b to the lower bushing 109, 109a, 109b at a predetermined distance 122 from the standoff barrel 104. An installer can base the predetermined distance 122 on the thickness of the panel 102 and/or one or more other physical properties of the panel 102. In at least one implementation, the installer can use a positioning tool 130 to secure the upper bushing 112, 112a, 112b to the lower bushing 109, 109a, 109b at the predetermined distance 122. In particular, the installer can position one or more teeth 136 of the positioning tool 130 into one or more recesses 113 of the upper bushing 112, 112a, 112b. The installer can then turn the positioning tool 130, thereby tightening the upper bushing 112, 112a, 112b onto the lower bushing 109, 109a, 109b. The installer can advance the positioning tool 130 until the shoulder 134 of the positioning tool 130 makes contact with the distal surface 102b of the panel 102.

The method can further involve aligning the at least one through hole 102d with the standoff barrel 104. The method can then involve positioning a fastener 106 in the through hole 102d of the panel 102 and securing the fastener 106 to the standoff barrel 104. As described above, in at least one implementation, the standoff barrel 104 can have threads configured to mate with the threads of the threaded rod 108 of the fastener 106. Consequently, to secure the fastener 106 to the standoff barrel 104, the installer can thread the fastener 106 into the standoff barrel 104. The installer can advance the fastener 106 until the upper bushing 112, 112a, 112b prevents further advancement of the fastener 106, which can ensure proper positioning and prevent application of excessive force onto the panel 102.

As the forgoing methods illustrate, systems and components of the present invention provide a great deal of versatility in mounting panels. In particular, the systems and components of the present invention enable panels to be secured to support surface using various components, which allow for simple and fast assembly, protect the panel from damage, and provide a pleasing aesthetic. Furthermore, as described above, the systems and components of the present invention allow the use of various panels, which can have numerous sizes, thickness, and structures (i.e., single- or multi-layered panels, such as decorative glass laminates), which can be safely secured to one or more support surfaces 101.

The present invention may be embodied in other specific forms without departing from its spirit or essential characteristics. The described embodiments are to be considered in all respects only as illustrative and not restrictive. For example, the fastener 106 shown and described in the figures is a one piece fastener. In other implementations, the fastener 106 can comprise two or more pieces. In particular, the fastener 106 can comprise a threaded rod and a head that is removably attachable to the threaded rod. The scope of the invention is, therefore, indicated by the appended claims rather than by the foregoing description. All changes that come within the meaning and range of equivalency of the claims are to be embraced within their scope.

We claim:

1. An adjustable bushing assembly, comprising:
a standoff barrel;
a fastener configured to be secured to the standoff barrel;
a lower bushing disposed configured to be positioned between the fastener and the standoff barrel; and
an upper bushing variably securable to the lower bushing in any of a plurality of positions, the upper bushing being configured to limit how far the fastener can be advanced with respect to the standoff barrel.

2. The adjustable bushing assembly as recited in claim 1, wherein the upper bushing has a first thread and a lower bushing has a second thread, and the first and second threads are configured to engage one another.

3. The adjustable bushing assembly as recited in claim 2, wherein the fastener further comprises a threaded rod with a third thread, a standoff barrel further comprises a fourth thread, and the third and the fourth threads are configured to engage one another.

4. The adjustable bushing assembly as recited in claim 3, wherein the first thread of the upper bushing and the third thread of the fastener have dissimilar thread handedness.

5. The adjustable bushing assembly as recited in claim 1, wherein the upper bushing has an internal thread, the lower bushing has an external thread, and the internal thread of the upper bushing is configured to engage the external thread of the lower bushing.

6. The adjustable bushing assembly as recited in claim 1, wherein the lower bushing is integrated into the standoff barrel.

7. The adjustable bushing assembly as recited in claim 1, wherein the upper bushing is configured to be secured to the lower bushing using a positioning tool.

8. The adjustable bushing assembly as recited in claim 1, wherein the lower bushing is recessed within the standoff barrel.

9. The adjustable bushing assembly as recited in claim 8, wherein the upper bushing, the lower bushing, the standoff barrel, and the fastener are disposed substantially concentrically to each other.

10. The adjustable bushing assembly as recited in claim 1, wherein the upper bushing and the lower bushing are configured to be press fit or snap fit together.

11. A panel mounting system, comprising:
one or more adjustable bushing assemblies for securing a panel to a support surface, each of the adjustable bushing assemblies comprising:
a standoff barrel;
a fastener secured to the standoff barrel;
a lower bushing positioned between the fastener and the standoff barrel; and
an upper bushing selectively secured to the lower bushing so as to be spaced from the standoff barrel at a predetermined distance; and
a panel secured between the standoff barrel and the fastener, the panel having a thickness less than the predetermined distance such that upper and lower bushings prevent the fastener from being advanced into the panel.

12. The system as recited in claim 11, further comprising a proximal washer positioned between the standoff barrel and a proximal surface of the panel.

13. The system as recited in claim 11, further comprising a distal washer having a cylindrical body and a flange, wherein the flange is positioned between the flat proximal surface of the head of the fastener and a distal surface of the panel.

14. The system as recited in claim 11, wherein the lower bushing is integrated into the standoff barrel.

15. The system as recited in claim 11, wherein the upper bushing has a first thread and a lower bushing has a second thread, and the first and second threads are configured to engage one another.

16. A method of mounting a panel to one or more adjustable bushing assemblies, each adjustable bushing assembly comprising a standoff barrel, a fastener, a lower bushing, and an upper bushing, the method comprising:
providing a panel having a thickness and at least one through hole;
securing the standoff barrel to a support surface;
selectively securing the upper bushing to the lower bushing at a predetermined distance from the standoff barrel based on the thickness of the panel;
aligning the at least one through hole with the standoff barrel;
positioning a fastener in the through hole of the panel and securing the fastener to the standoff barrel; and
advancing the fastener relative to the standoff barrel until the upper bushing prevents further advancement of the fastener.

17. The method as recited in claim 16, further comprising using a positioning tool to secure the upper bushing to the lower bushing at the predetermined distance.

18. The method as recited in claim 17, further comprising:
positioning one or more teeth of the positioning tool into one or more recesses of the upper bushing; and
advancing the positioning tool toward the standoff barrel until a shoulder of the positioning tool abuts against the panel.

19. The method as recited in claim 16, wherein selectively securing the upper bushing to the lower bushing comprises threading the upper bushing to the lower bushing.

20. The method as recited in claim 16, further comprising:
positioning a first washer between the panel and the standoff barrel; and
positioning a second washer between the panel and the fastener.
